(19) United States
(12) Patent Application Publication
(10) Pub. No.: US 2016/0092780 A1
(43) Pub. Date: Mar. 31, 2016

(54) SELECTING MEDIA USING INFERRED PREFERENCES AND ENVIRONMENTAL INFORMATION

(71) Applicant: Pandora Media, Inc., Oakland, CA (US)

(72) Inventors: Rhodes Alan Kelley, San Francisco, CA (US); Valery Penchev Rashkov, San Francisco, CA (US); Gordon Rios, San Francisco, CA (US); Kyle George Lind, Lafayette, CA (US)

(21) Appl. No.: 14/500,364

(22) Filed: Sep. 29, 2014

(51) Int. Cl. G06N 5/04; G06Q 20/08; H04L 29/08

(52) U.S. Cl. CPC G06N 5/048; H04L 67/32; G06Q 20/085

(57) ABSTRACT

A content server provides for presentation to a user media items to a client device. Feedback is collected from the client device indicating user preference information for the media items and collects environmental information from the client device describing environmental configurations present during the presentation of the media items. Media features are identified that characterize the media items, and correlates the collected feedback, including sequences of feedback, with the identified media features to identify preferences of the user for the identified media features given particular configurations of the environmental information. The content server determines a current configuration of environmental information for the client device, and selects a selected media item responsive to the current configuration of environmental information and the preferences of the user for the identified media features or media items given particular configurations of the environmental information. The content server provides the selected media item to the client device.

### BACKGROUND

1. Field of Disclosure

The present invention generally relates to the delivery of content, and more specifically to ways of generating media playlists for a user based on inferred preferences of the user.

2. Description of the Related Art

Many users utilize their digital devices to consume media content. For example, a user may use a media application on their digital device to play a media item (e.g., a song). In some instances, the media application may generate playlists for the user based on express feedback from the user indicating whether they like (e.g., give a song a thumbs up) or dislike a media item (e.g., give a song a thumbs down). Express feedback is feedback provided by a user that directly expresses a user's like or dislike for a media item. However, generating playlists based solely on express feedback may be burdensome to the user, as it requires actions from the user to indicate preferences.

### SUMMARY

The above and other needs are met by a computer-implemented method, a non-transitory computer-readable storage medium storing executable code, and a device for selecting media items based on inferred user preferences.

One embodiment of the computer-implemented method for selecting media items based on inferred user preferences, comprises providing media items to a client device used by a user, the client device presenting the media items to the user. Feedback is collected from the client device indicating user preference information for the media items and environmental information is collected from the client device describing environmental configurations present during presentation of the media items to the user. Media features are identified that characterize the media items, and the collected feedback is correlated with the identified media features to identify preferences of the user for the identified media features given particular configurations of the environmental information. A current configuration of environmental information for the client device is determined, and media item is selected responsive to the current configuration of environmental information and the preferences of the user for the identified media features given particular configurations of the environmental information. The selected media item is provided to the client device.

One embodiment of a non-transitory computer-readable storage medium storing executable computer program instructions for selecting media items based on inferred user preferences, comprises providing media items to a client device used by a user, the client device presenting the media items to the user. Feedback is collected from the client device indicating user preference information for the media items and environmental information is collected from the client device describing environmental configurations present during presentation of the media items to the user. Media features are identified that characterize the media items, and the collected feedback is correlated with the identified media features to identify preferences of the user for the identified media features given particular configurations of the environmental information. A current configuration of environmental information for the client device is determined, and media item is selected responsive to the current configuration of environmental information and the preferences of the user for the identified media features given particular configurations of the environmental information. The selected media item is provided to the client device.

One embodiment of a device for selecting media items based on inferred user preferences, comprises a processor configured to execute modules, and a memory storing the modules. The modules include a media selection module configured to provide media items to a client device used by a user, the client device presenting the media items to the user. The modules also include a collection module configured to collect feedback from the client device indicating user preference information for the media items and to collect environmental information from the client device describing environmental configurations present during presentation of the media items to the user. The modules also include a feedback analysis module configured to identify media features that characterize the media items. The modules also include a correlation module configured to correlate the collected feedback with the identified media features to identify preferences of the user for the identified media features given particular configurations of the environmental information. The media selection module is further configured to determine a current configuration of environmental information for the client device. The media selection module is further configured to select a selected media item responsive to the current configuration of environmental information and the preferences of the user for the identified media features given particular configurations of the environmental information, and provide the selected media item to the client device

### BRIEF DESCRIPTION OF DRAWINGS

FIG. 1 is a high-level block diagram illustrating an embodiment of an environment for generating playlists based on inferred user preferences.

FIG. 2A is a high-level block diagram illustrating a detailed view of a client device of FIG. 1, according to one embodiment.

FIG. 2B is an example user interface provided by the application of FIGS. 1 and 2A, according to one embodiment.

FIG. 3 is a high-level block diagram illustrating a detailed view of the content server of FIG. 1, according to one embodiment.

FIG. 4 is a flowchart illustrating a process of selecting a media item based on correlations between preferred media features and specific configurations of environmental information according to one embodiment.

FIG. 5 is a high-level block diagram illustrating an example computer for implementing the entities shown in FIG. 1.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures and may indicate similar or like functionality.

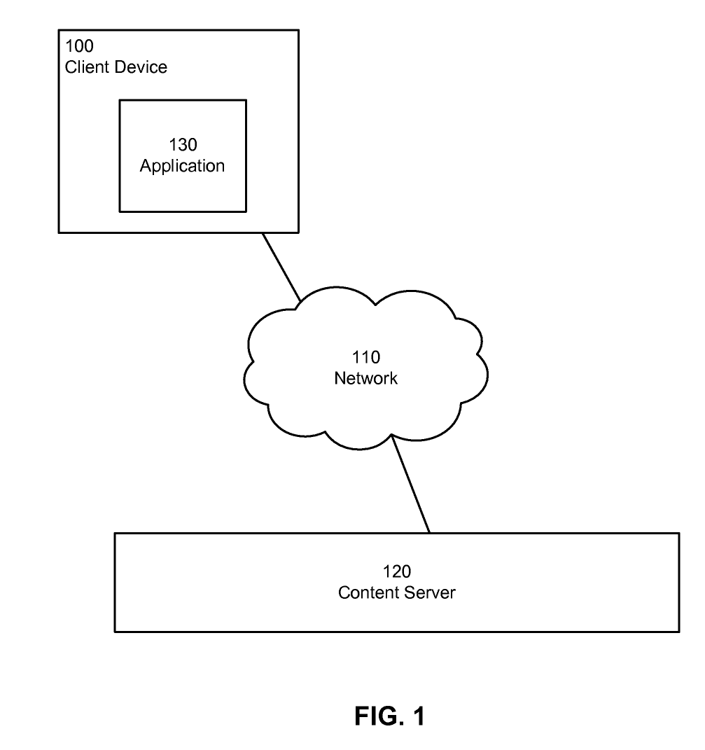

FIG. 1 is a high-level block diagram illustrating an embodiment of an environment for generating playlists based on inferred user preferences. The environment includes a client device 100 connected by a network 110 to a content server 120. Here only one client device 100 and content server 120 are illustrated but there may be multiple instances of each of these entities. For example, there may be thousands or millions of client devices 100 in communication with one or more content servers 120.

The network 110 provides a communication infrastructure between the client devices 100 and the content servers 120. The network 110 is typically the Internet, but may be any network, including but not limited to a Local Area Network (LAN), a Metropolitan Area Network (MAN), a Wide Area Network (WAN), a mobile wired or wireless network, a private network, or a virtual private network.

The client devices 100 are computing devices such as smartphones with an operating system such as ANDROID® or APPLE® IOS®, tablet computers, laptop computers, desktop computers, electronic stereos in automobiles or other vehicles, or any other type of network-enabled device on which digital content may be listened to or otherwise experienced. Typical client devices 100 include the hardware and software needed to input and output sound (e.g., speakers and microphone) and images, connect to the network 110 (e.g., via Wifi and/or 4G or other wireless telecommunication standards), determine the current geographic location of the client devices 100 (e.g., a Global Positioning System (GPS) unit), and/or detect motion of the client devices 100 (e.g., via motion sensors such as accelerometers and gyroscopes).

The client device 100 includes an application 130 that allows interaction with the content server 120. For example, the application 130 could be a browser that allows a user of the client device 100 to obtain content by browsing a web site of the content server 120. As another example, the application 130 could be a dedicated application specifically designed (e.g., by the organization responsible for the content server 120) to enable interactions with the content server 120 and its content.

The application 130 presents media items, responsive to a user selecting and/or creating a particular media channel. A media channel is a playlist of media items that are grouped together, where the media items share one or more common media features. A media item is a form of media content and is characterized by a set of media features that describe musicological features of the item (e.g., gender of singer, tempo, style). In one particular embodiment referred to throughout the remainder of the specification, the media item is audio content, such as a song, piece of music, or audio recording. It is appreciated, however, that in other embodiments a media item alternatively and/or additionally include other forms of digital content, such as a video, movie, slideshow, or image. Thus, subsequent references to the media item or other audio-related terminology could equally apply to (for example) viewing videos or otherwise experiencing media provided by the content server system 100 in other embodiments. The application 130 requests content associated with the requested media channel from the content server 120. The application 130 receives media items (e.g., the media item is streamed) associated with the requested media channel and presents the media items to the user.

The application 130 collects feedback and environmental information from the client device 100 presenting the media items. The feedback may include express feedback and/or implicit feedback. Express feedback is feedback provided by the user that directly expresses the user's preferences (i.e., like or dislike) for a media item. For example, express feedback may be a user rating of a media item, a user selecting a thumbs up icon or thumbs down icon to respectively indicate approval or disapproval, or some other action by the user that directly expresses his/her preference for a media item. In contrast, implicit feedback is feedback that implicitly describes a user's preferences for a media item. Implicit feedback may be positive or negative. Examples of positive implicit feedback include allowing a media item to play through until completion, sharing a media channel with another user of the content server 120, purchasing a media item that is being presented, changing a station channel (media channel), and adding a media channel based on the media item. Examples of negative implicit feedback include the user skipping a media item after partial playback of the media item, pausing presentation of a media item, and changing a media channel during playing of a media item. Additionally, in some embodiments, the application 130 collects sequences of express feedback, implicit feedback, or some combination thereof.

Environmental information is data describing the physical environment of the client device 100 during which the media item is being presented. Environmental information may be, e.g., the type of client device 100 (e.g., personal computer, smart phone, etc.), location of the client device 100, rate of movement of the client device 100, the current time in the local time zone in which the client device is located, or other information describing the surroundings and/or conditions in which the feedback is collected. The application 130 provides the collected feedback and associated environmental information to the content server 120.

The content server 120 generates media channels that are specific to a user of the client device 100. The content server 120 may initially generate a media channel based on a seed input from the user (e.g., name of a song or band) using a list of global list of media items associated with the input. The content server 120 receives requests for content from the client devices 100. The content server 120 identifies a media channel associated with the request for content, and streams media items associated with the media channel to the requesting client device 100.

The content server 120 collects feedback (i.e., express feedback and/or implicit feedback) and environmental information from the client device 100 associated with the user. Over time, the same media item may be provided to the client device 100 and presented to the user many times. The content server 120 collects feedback and environmental information for these multiple presentations of the media item. The collected information associated with the media item can result in a large pool of collected express feedback and/or implied feedback for various configurations of environmental information that are associated with different instances of presentation by the client device 100.

By creating a robust set of collected feedback and environmental information for each media item, the content server 120 is able to effectively analyze the collected feedback and environmental information to identify correlations between media item preferences of the user and various configurations of environmental information. These media items are represented by associated sets of media features that characterize the media items. In some embodiments, the identified correlations therefore indicate a user's preference for particular media features of media items when subject to specific configurations of environmental information. For example, the content server 120 may determine from the collected feedback and environmental information that the user dislikes presentation of media items characterized by certain media features while the client device 100 is located at a particular location. In other embodiments, the identified correlations indicate a user's preference for a particular media item. The correlations may be based largely on implicit feedback and/or combinations of implicit feedback received from the client device 100. Thus, the content server 120 is able to identify correlations between preferences of a user for media items and/or media features of media items given configurations of environmental information without requesting additional action on the part of the user.

The content server 120 selects media items using the identified correlations and current configurations of environmental information received from the client devices 100. For a user associated with a client device 100, the content server 120 uses the identified correlations and a current configuration of environmental information to identify media features of media items and/or media items that the user prefers while the client device 100 is subject to the given configuration of environmental information. In some embodiments, the content server 120 selects a media item using the identified media features. The content server 120 may alternatively select media items using the media items identified as being preferred by the user. The content server 120 provides the selected media item to the client device 100. Accordingly, the content server 120 is able to select media items for presentation to the user based on media items and/or media features liked or disliked by the user given a particular configuration of environmental information.

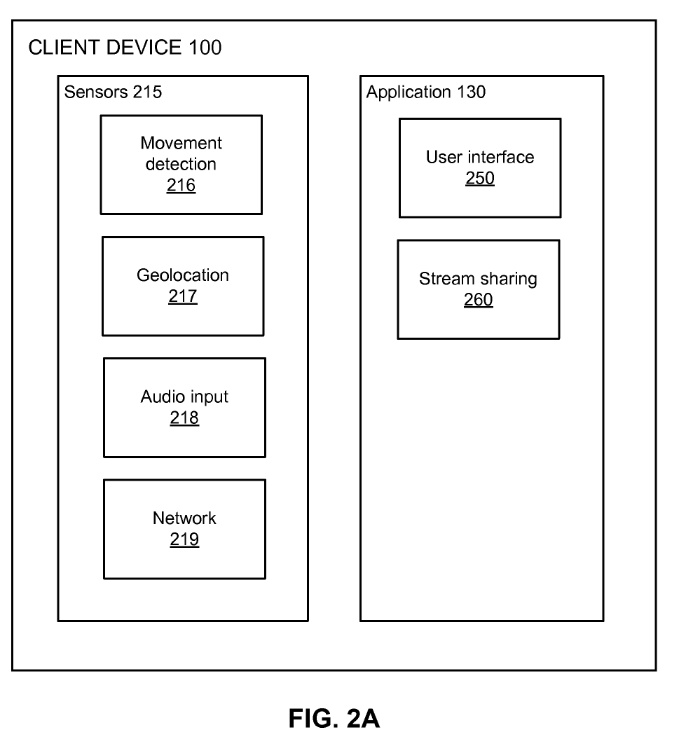

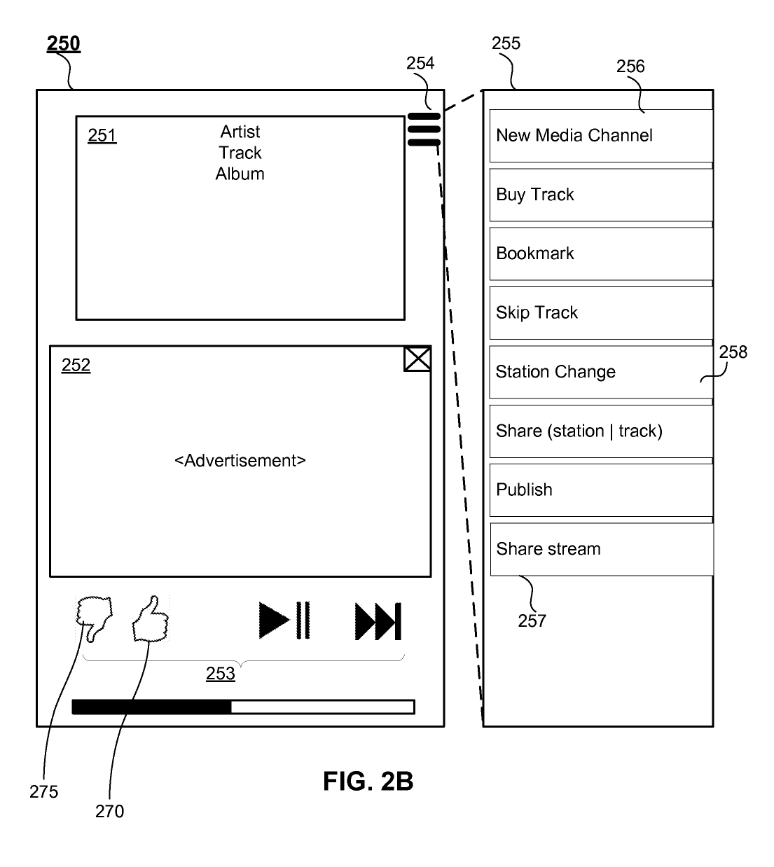

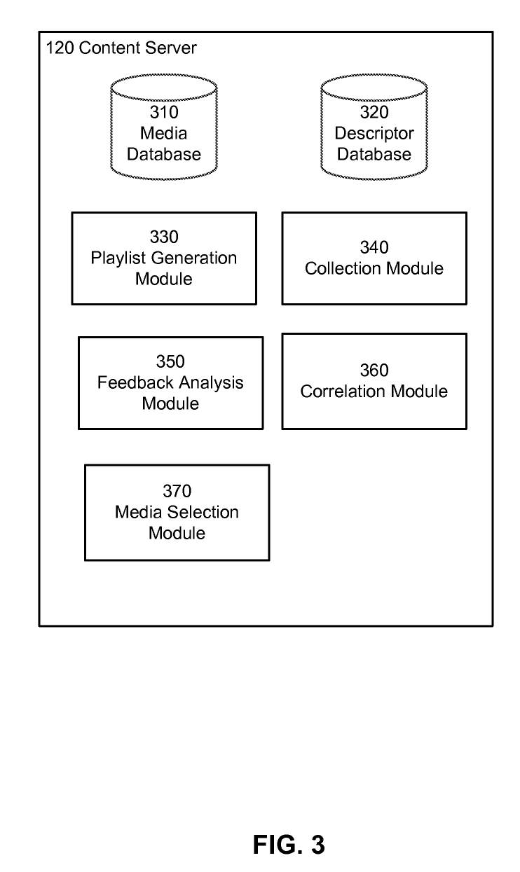

The client device 100 and content server 120 are now described in more detail with respect to FIGS. 2A, 2B and 3, below. FIG. 2A is a high-level block diagram illustrating a detailed view of a client device 100 of FIG. 1, according to one embodiment.

A client device has a set of sensors 215 that collect data associated with properties of the client device 100, such as environmental information about the physical environment or state of the client device. Different types or models of client devices may have different sensors. Illustrated in the embodiment of FIG. 2A are a set of sensors 215 particularly appropriate for a smartphone client device, though it is appreciated that other client devices 100 may have different sensors.

The illustrated sensors 215 include a movement detection sensor 216, which detects properties of movement of the client device 100 such as speed, acceleration, or direction. The movement detection sensor 216 may include accelerometers or gyroscopes, for example. Another illustrated sensor is the geolocation sensor 217, which determines a particular geographic location of the client device 100, such as coordinates provided by Global Positioning System (GPS) or other geographic location systems. Another illustrated sensor is the audio input sensor 218, such as a microphone, which detects and measures sound. Another illustrated sensor is a network sensor 219, which identifies a network(s) that the client device 100 is currently using for communication (e.g., network 110), such as a Wifi network, or a 4G other telecommunication network.

The client device 100 may also include an application 130 specifically designed to operate with the content server 120. For example, in one embodiment the application includes a user interface 250 for interacting with an audio stream, as illustrated in FIG. 2B. The example user interface 250 includes a description area 251 providing information on a currently-playing song, an optional image advertisement 252, controls 253 for registering appreciation for (via a thumbs up button 270), or dislike of (via a thumbs down button 275), the song currently playing, and to pause/play or skip the current song. The thumbs up button 270 and the thumbs down button 275 enable the user to provide express feedback about the media item being presented.

The example user interface 250 also includes a set of options 255 (shown in response to selection of popup control 254) that include an option 256 to request an audio stream that includes songs (tracks) associated with a particular media channel, and an option 257 to share a stream with other nearby users of the content server 120 so that the other users can also (for example) react to the currently-playing song, such as registering appreciation for, or dislike of, the song, sharing the song, bookmarking the song, or the like. The set of options 255 also include an option 258 to change to a different station (i.e., media channel).

Returning again to FIG. 2A, in some embodiments the application 130 includes a stream sharing module 260 that, when requested by a user (e.g., via the option 257 of FIG. 2B), makes the currently-playing stream accessible to others, and (for applications 130 on client devices not currently streaming) allows their users to interact with the stream. For example, on the client device 100 doing the streaming, the stream sharing module 260 may broadcast the availability of the stream to other client devices 110 using short-range wireless communications; and on client devices located nearby, the sharing module 260 may note the availability of the stream in the user interface, and in response to the user accepting the shared stream, show the playing stream along with controls allowing the user to comment on or otherwise interact with the stream.

Turning now to a discussion of the structure of the content server 120, FIG. 3 is a high-level block diagram illustrating a detailed view of modules within the content server 120 according to one embodiment. Some embodiments of the content server 120 have different modules than those described here. Similarly, the functions can be distributed among the modules in a different manner than is described here. The content server 120 is comprised of modules including a media database 310, a descriptor database 320, a playlist generation module 330, a collection module 340, a feedback analysis module 350, a correlation module 360, and a media selection module 370.

The media database 310 stores information relating to media items, such as the media items and associated metadata (e.g., artist, name of track, etc.), playlists, and mappings of media items to media features. As mentioned above, the media features (also referred to as musicological features) describe musicological characteristics of media items. For example, if the media item is a song, the media features of the song may indicate the underlying musicological characteristics of the song such as e.g., the gender of the singer, the type of background vocals, the tempo, the quality of the tones (e.g., pure or distorted), whether the melody dominates the composition, and an amount of gospel influence. A given media item may have many media features, such as 100-500 media features. In one embodiment, the mapping of media items to media features is established using the MUSIC GENOME PROJECT database created by PANDORA MEDIA, INC. of Oakland, Calif.

The descriptor database 320 stores information describing user preferences for media items and media features in association with given environmental configurations. In one embodiment, this information is represented as preference descriptors. These descriptors associate a user's preference information for a media item with the environmental configuration present when the media item was presented to the user. In addition, the descriptors may associate the user's preference information and the environmental configuration with the media item features that characterize the media item. Since a media item may be presented to a user multiple times, there may be multiple preference descriptors for a user for a media item (e.g., one for every time a media item characterized by the media feature is presented by the client device 100 to the user).

The playlist generation module 330 generates media item playlists. The playlist generation module 330 receives a seed value from the user. A seed value is an input from the user that describes what type of media channel he/she would like formed. A seed value may be, e.g., a name of a song, a name of a band, a name of genre of music, etc., and in some embodiments, the seed value may be characterized by a plurality of media features. The playlist generation module 330 may extract media features from the seed value using, e.g., the mappings of media items to corresponding media features in the media database 310. The playlist generation module 330 uses the media features and the mappings of media items to media features to dynamically generate a media item playlist of media items having media features associated with the seed value. For example, given a seed value of a band, the playlist generation module 330 identifies media features that characterize the band. The playlist generation module 330 then identifies songs with the same or similar media features. The playlist generation module 330 then uses the identified songs to generate a media playlist which is associated with the band.

The collection module 340 collects feedback and environmental information from the client devices 100. The collection module 340 maintains the collected feedback and environmental information from the client devices 100 for each user. The stored feedback and environmental information includes express feedback, implicit feedback, and configurations of environmental information that are associated with presentations of the media items to the users. In one embodiment, the collection module 340 maintains a distinct set of feedback and environmental information for each presentation of a media item to a user. Since the same media item may be presented to a user multiple times, the collection module 340 may maintain multiple sets of feedback and environmental information associated with the media item and the user. The collected feedback indicates user preference information, such as express (e.g., thumbs up) and inferred preferences that indicate whether a user liked or disliked a media item during a presentation having a particular environmental configuration.

The feedback analysis module 350 analyzes the collected feedback and to determine the users' preferences for media items (i.e., likes and dislikes) and the magnitudes of these preferences (i.e., the amount of the likes and dislikes). In some embodiments, the feedback analysis module 350 analyzes for a media item a series of collected feedback for that media item to determine a user's preference for the media item. In one embodiment, the feedback analysis module 350 represents the preferences and magnitudes as a preference score. Note, for each user, each media item in each media playlist for that user has its own preference score. For example, the preference score may be represented as a value between −1 and 1, where a negative value indicates dislike and a positive value indicates like, and the absolute value indicates the magnitude of the like or dislike. To compute the score, the feedback analysis module 350 assigns weights to the various types of feedback that may be present in the user preference information. Very strong signals of preference (e.g., an express thumbs up or thumbs down) are afforded relatively higher weights, while weaker signals of preference such as the various types of implicit feedback are afforded relatively lower weights. The weighted feedback is then combined to produce the preference score. As a given media item may be presented to a given user multiple times, the feedback analysis module 350 may produce multiple preference scores for a media item and user. Each of these preference scores is also associated with the environmental configuration present during the instance that the media item was presented to the user. Accordingly, each media item presented to the user is associated with a one or more preferred media scores, where each preference score describes the user's preference for the media item subject to a particular configuration of environmental information.

In one embodiment, the feedback analysis module 350 represents the preferences and magnitudes for a media item as a preference score representing a probability that if the media item is presented to the user the user would allow the media item to play through to completion. In this context, the feedback analysis module 350 generates the preference score using the collected feedback and configurations of environmental information. In some embodiments, the feedback analysis module 350 uses collected feedback including a series of implicit feedback for the media item to generate a preference score for the media item. For example, if the series of collected feedback indicates, for a given configuration of environmental information, that 8 out of the last 10 times the media item was presented to the user it was played through to completion, the feedback analysis module 350 may determine a relatively high preference score for the media item (e.g., 80% chance that the user would allow the media item to play through to completion).

The feedback analysis module 350 also associates the preference scores and environmental configurations with the media features that characterize the media items. For a given presentation of a media item to a user, the feedback analysis module 350 uses the mappings of media items to associated media features described in the media database 310 to identify the specific media features present in the media item. The feedback analysis module 350 then associates a user's preference score for the presentation of the media item with the constituent media features of the media item, and also associates the environmental configuration of that presentation with the media features. Since many media items are presented to a typical user, and a given media item may be presented multiple times, the feedback analysis module 350 through this process may generate a large amount of information describing the user's preferences for various media item features in various environmental configurations. This information is stored as preference descriptors in the descriptor database 320.

In some embodiments, the correlation module 360 uses the preference descriptors to correlate user preferences with media features and configurations of environmental information to ascertain user preferences for particular media features during particular configurations of environmental information. For a user, the correlation module 360 gathers the preference descriptors associated with the user, and then analyzes, e.g., using machine learning techniques, the preference descriptors to determine how the user's preference scores for the features correlate with particular environmental configurations. For example, the correlation module 360 may determine that the user prefers a particular media feature (e.g., likes music with a fast tempo) while subject to a particular configuration of environmental information (e.g., when the device is moving in a manner that suggest the user is running).

In other embodiments, the correlation module 360 ranks the media items in the media playlist by preference score for various configurations for environmental information. Thus, given a particular configuration of environmental information, the correlation module 360 is able to determine what media item has the highest preference score.

The media selection module 370 selects a media item using the correlations or rankings and current environmental information received from the client device 100. The media selection module 370 receives environmental information from the client device 100. The environmental information may be received periodically, with requests for content from the client device 100 or in response to a request sent to the client device 100 from the content server 120. The received environmental information describes a current configuration of environmental information for the client device 100. In some embodiments, the media selection module 370 compares the received environmental information with the correlations produced by the correlation module 360 to identify media features that the user prefers given the current environmental configuration (e.g., fast tempo music while the user is running). The media selection module 370 then selects a media item from the media database 310 based on these preferences, and provides the selected media item to the client device 100. Alternatively, in some embodiments, the media selection module 370 compares the received environmental information with the rankings produced by the correlation module 360 to identify media items that the user prefers given the current environmental configuration. In some embodiments, the media selection module 370 may remove from consideration media items in the media database 310 that have preference scores below a threshold value, thus helping prevent disliked media items from being selected. Accordingly, the media selection module 370, in effect, customizes the media playlist to the user's preferences given the current environmental configuration.

In some embodiments, the correlation module 360 does not have a threshold number of feature preference descriptors that are associated with one or more media features and/or particular configurations of environmental information. The threshold number may be, e.g., a number that is large enough such that correlations between a user's preferences for specific media features and the specific configurations of environmental information may be determined. The correlation module 360 then provides an instruction that causes the media selection module 370 to select a media item characterized by particular media features when a particular configuration of environmental information is received from the client device 100. Accordingly, the correlation module 360 is able to control the media features of a media item that are provided to the client device 100 given specific configurations of environmental information. This allows the correlation module 360 to gather express and/or implicit feedback in a controlled manner such that it is able to effectively identify correlations between preferred media features of media items subject to various configurations of environmental information.

In some embodiments, the media selection module 370 may select media items using a playlist that is associated with the user. The media selection module 370 may then select a media item from the media database 310 that is on the media playlist and provide it to the user device 100.

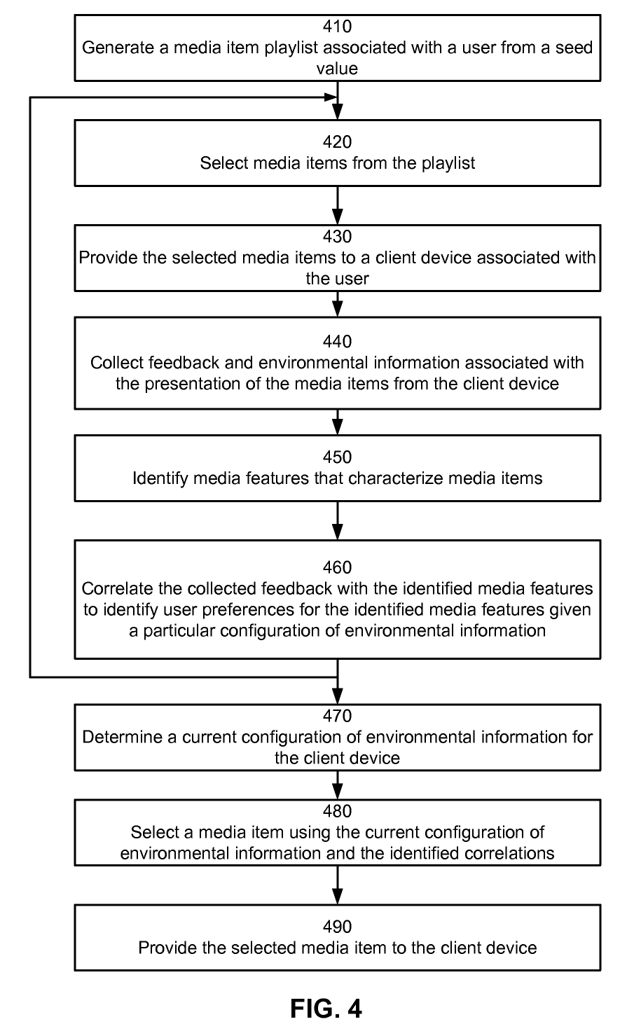

FIG. 4 is a flowchart illustrating a process of selecting a media item based on correlations between preferred media features and specific configurations of environmental information according to one embodiment. In one embodiment, the process of FIG. 4 is performed by the content server 120. Other entities may perform some or all of the steps of the process in other embodiments. Likewise, embodiments may include different and/or additional steps, or perform the steps in different orders.

The content server 120 generates 410 a media item playlist associated with a user from a seed value. The content server 120 selects 420 media items from the media item playlist. The selections may be based in part on differing configurations of environmental information. In addition, the media items may be selected to cause feedback to be received for the same and different media items (and media features) under differing configurations of environmental information. The content server 120 provides 430 the selected media items to the client device 100 associated with the user, and the client device presents the media items to the user.

The content server 120 collects 440 feedback and environmental information associated with the presentation of the media items from the client device 100. The feedback indicates the user's preferences (i.e., contains user preference information) for the media items during particular configurations of environmental information. Over time, the same media item may be provided to the client device 100 and presented to the user multiple times, resulting in a pool of collected user preference information for the media item for various configurations of environmental information. The content server 120 analyses the user preference information to determine user preference scores for the media items for the different configurations of environmental information.

The content server 120 identifies 450 media features that characterize the media items associated with the collected feedback and environmental information. The media features may be identified using the mappings of media items to corresponding media features associated with the media items in the media database 310. The content server 120 associates the user preference scores and configurations of environmental information with the identified media features and saves these associates as preference descriptors.

The content server 120 correlates 460 the collected feedback with the identified media features to identify user preferences for the identified media features given particular environmental configurations. For a user, the correlation module 360 gathers the preference descriptors associated with the user, and then analyzes, e.g., using machine learning techniques, the preference descriptors to determine how the user's preference scores for the features correlate with particular environmental configurations.

The content server 120 may determine that a threshold number of preference descriptors that are associated with one or more media features and/or environmental configurations have not yet been generated. In some embodiments, if the threshold is not met, the process flow moves to step 420, and the content server 120 selects a media item characterized by the desired media features for providing to the client device 100. Thus, allowing the content server 120 to gather feedback associated with media features of media items in a controlled manner subject to differing environmental configurations.

The content server 120 determines 470 a current configuration of environmental information for the client device 100. For example, the content server 120 may receive a content request from the client device 100 that includes information describing the current configuration of the environmental of the client device 100. The content server 120 selects 480 a media item using the current configuration of environmental information and the correlations, and provides 490 the selected media item to the client device 100.

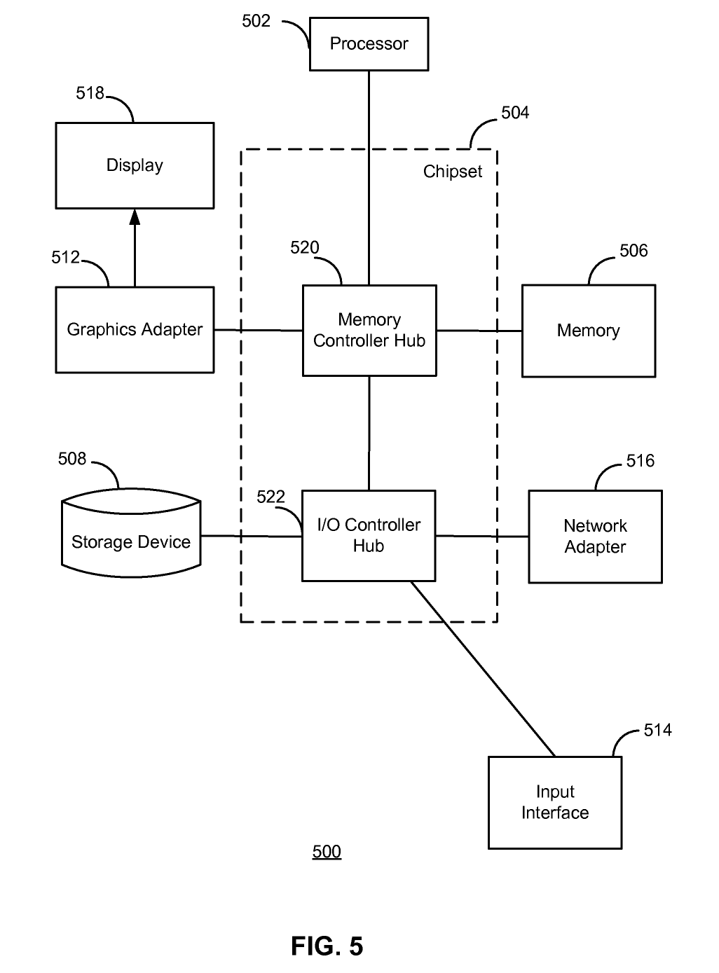

Turning now to a discussion of the implementation of client device 100 and/or the content server 120, FIG. 5 is a high-level block diagram illustrating an example computer 500 for implementing the entities shown in FIG. 1. The computer 500 includes at least one processor 502 coupled to a chipset 504. The chipset 504 includes a memory controller hub 520 and an input/output (I/O) controller hub 522. A memory 506 and a graphics adapter 512 are coupled to the memory controller hub 520, and a display 518 is coupled to the graphics adapter 512. A storage device 508, an input device 514, and network adapter 516 are coupled to the I/O controller hub 522. Other embodiments of the computer 500 have different architectures.

The storage device 508 is a non-transitory computer-readable storage medium such as a hard drive, compact disk read-only memory (CD-ROM), DVD, or a solid-state memory device. The memory 506 holds instructions and data used by the processor 502. The input interface 514 is a touch-screen interface, a mouse, track ball, or other type of pointing device, a keyboard, or some combination thereof, and is used to input data into the computer 500. In some embodiments, the computer 500 may be configured to receive input (e.g., commands) from the input interface 514 via gestures from the user. The graphics adapter 512 displays images and other information on the display 518. The network adapter 516 couples the computer 500 to one or more computer networks.

The computer 500 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 508, loaded into the memory 506, and executed by the processor 502.

The types of computers 500 used by the entities of FIG. 1 can vary depending upon the embodiment and the processing power required by the entity. For example, the content server 120 can run in a single computer 500 or multiple computers 500 communicating with each other through a network such as in a server farm. The computers 500 can lack some of the components described above, such as graphics adapters 512, and displays 518.

### Other Considerations

Some portions of the above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for selecting content based on correlations between preferred media features and specific configurations of environmental information. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed herein.

1. A computer-implemented method for selecting media items based on inferred user preferences, comprising:
providing media items to a client device used by a user, the client device presenting the media items to the user;
collecting feedback from the client device indicating user preference information for the media items and collecting environmental information from the client device describing environmental configurations present during presentation of the media items to the user;
identifying media features that characterize the media items;
correlating the collected feedback with the identified media features to identify preferences of the user for the identified media features given particular configurations of the environmental information;
determining a current configuration of environmental information for the client device;
selecting a selected media item responsive to the current configuration of environmental information and the preferences of the user for the identified media features given particular configurations of the environmental information; and
providing the selected media item to the client device.

2. The method of claim 1, wherein collecting feedback comprising user preference information comprises collecting implicit feedback that implicitly indicates the user's positive or negative preferences for the media items presented to the user.

3. The method of claim 2, wherein the implicit feedback comprises feedback about a media item indicating at least one of the user:
allowing or not allowing the media item to present until completion;
pausing presentation of the media item;
changing a media channel during presentation of the media item;
sharing the media item with another user; and
purchasing the media item.

4. The method of claim 1, wherein collecting environmental information from the client device comprises selecting at least one type of environmental information from a group of types of environmental information consisting of:
a type of the client device;
a rate of movement of the client device; and
a current time in the local time zone in which the client device is located.

5. The method of claim 1, wherein the media items include music items and identifying media features that characterize the media items further comprises:
identifying musicological features of the music items.

6. The method of claim 1, further comprising:
computing preference scores indicating the user's preferences for the media items during particular configurations of environmental information; and
associating the preference scores and the particular configurations of environmental information with the media features that characterize the media items;
wherein the correlating uses the associations of the preference scores and particular configurations of environmental information with the media features to identify the preferences of the user.

7. The method of claim 1, wherein selecting a media item comprises:
identifying media features that the user prefers given the current configuration of environmental information; and
selecting a media item having the media features that the user prefers given the current configuration of environmental information.

8. A non-transitory computer-readable storage medium storing executable computer program instructions for selecting media items based on inferred user preferences, the instructions executable to perform steps comprising:
providing media items to a client device used by a user, the client device presenting the media items to the user;
collecting feedback from the client device indicating user preference information for the media items and collecting environmental information from the client device describing environmental configurations present during presentation of the media items to the user;
identifying media features that characterize the media items;
correlating the collected feedback with the identified media features to identify preferences of the user for the identified media features given particular configurations of the environmental information;
determining a current configuration of environmental information for the client device;
selecting a selected media item responsive to the current configuration of environmental information and the preferences of the user for the identified media features given particular configurations of the environmental information; and
providing the selected media item to the client device.

9. The computer-readable medium of claim 8, wherein collecting feedback comprising user preference information comprises collecting implicit feedback that implicitly indicates the user's positive or negative preferences for the media items presented to the user.

10. The computer-readable medium of claim 9, wherein the implicit feedback comprises feedback about a media item indicating at least one of the user:
allowing or not allowing the media item to present until completion;
pausing presentation of the media item;
changing a media channel during presentation of the media item;
sharing the media item with another user; and
purchasing the media item.

11. The computer-readable medium of claim 8, wherein collecting environmental information from the client device comprises selecting at least one type of environmental information from a group of types of environmental information consisting of:
a type of the client device;
a rate of movement of the client device; and
a current time in the local time zone in which the client device is located.

12. The computer-readable medium of claim 8, wherein the media items include music items and identifying media features that characterize the media items further comprises:
identifying musicological features of the music items.

13. The computer-readable medium of claim 8, further comprising:
computing preference scores indicating the user's preferences for the media items during particular configurations of environmental information; and
associating the preference scores and the particular configurations of environmental information with the media features that characterize the media items;
wherein the correlating uses the associations of the preference scores and particular configurations of environmental information with the media features to identify the preferences of the user.

14. The computer-readable medium of claim 8, wherein selecting a media item comprises:
identifying media features that the user prefers given the current configuration of environmental information; and
selecting a media item having the media features that the user prefers given the current configuration of environmental information.

15. A device for selecting media items based on inferred user preferences, comprising:
a processor configured to execute modules; and
a memory storing the modules, the modules comprising:
a media selection module configured to provide media items to a client device used by a user, the client device presenting the media items to the user;
a collection module configured to collect feedback from the client device indicating user preference information for the media items and to collect environmental information from the client device describing environmental configurations present during presentation of the media items to the user;
a feedback analysis module configured to identify media features that characterize the media items;
a correlation module configured to correlate the collected feedback with the identified media features to identify preferences of the user for the identified media features given particular configurations of the environmental information; and
the media selection module is further configured to:
determine a current configuration of environmental information for the client device,
select a selected media item responsive to the current configuration of environmental information and the preferences of the user for the identified media features given particular configurations of the environmental information; and
provide the selected media item to the client device.

16. The device of claim 15, wherein the collection module is further configured to collect implicit feedback that implicitly indicates the user's positive or negative preferences for the media items presented to the user.

17. The device of claim 16, wherein the implicit feedback comprises feedback about a media item indicating at least one of the user:
allowing or not allowing the media item to present until completion;
pausing presentation of the media item;
changing a media channel during presentation of the media item;
sharing the media item with another user; and
purchasing the media item.

18. The device of claim 15, wherein the collected environmental information is selected from a group of types of environmental information consisting of:
a type of the client device;
a rate of movement of the client device; and
a current time in the local time zone in which the client device is located.

19. The device of claim 15, wherein the feedback analysis module is further configured to:
identify musicological features of the music items.

20. The device of claim 15, wherein the media selection module is further configured to:
identify media features that the user prefers given the current configuration of environmental information; and
select a media item having the media features that the user prefers given the current configuration of environmental information.
